(19) United States
(12) Patent Application Publication
(10) Pub. No.: US 2005/0003724 A1
(43) Pub. Date: Jan. 6, 2005

(54) Substrate for endless belt for use in papermaking applications

(76) Inventor: Keith FitzPatrick, Dieren (NL)

Correspondence Address: FROMMER LAWRENCE & HAUG, 745 FIFTH AVENUE- 10TH FL., NEW YORK, NY, 10151, US

(21) Appl. No.: 10/612,196

(22) Filed: Jul. 2, 2003

(51) Int. Cl. B32B 27/04; B32B 5/02; B32B 27/12; D03D 15/00

(52) U.S. Cl. 442/104; 442/189; 442/195; 442/239; 442/268; 442/286; 427/372.2; 427/402

(57) ABSTRACT

A substrate for an endless belt in a papermaking machine comprising a plurality of preformed layers coated or impregnated with a polymeric or rubber material. Each preformed layer may be a textile material. At least one layer contains a matrix of preformed reinforcing components. The individual layers are first coated with a polymer resin or rubber material and then combined/stacked and cured/bonded to form the substrate of the belt.

### BACKGROUND OF THE INVENTION

1. Field of the Invention

The present invention relates to paper industry process belts. Specifically, individual layers of preformed components are first coated or impregnated with a polymer resin and then combined to form a substrate of a belt for papermaking machine applications. More specifically, the substrate may be a laminate comprising a plurality of preformed layers coated or impregnated with a polymeric resin material. Each preformed layer may be a “textile layer” or a textile layer coated/impregnated with resin.

2. Description of the Prior Art

During the papermaking process, a cellulosic fibrous web is formed by depositing a fibrous slurry, that is, an aqueous dispersion of cellulose fibers, onto a moving forming fabric in a forming section of a paper machine. A large amount of water is drained from the slurry through the forming fabric, leaving the cellulosic fibrous web on the surface of the forming fabric.

The newly formed cellulosic fibrous web proceeds from the forming section to a press section, which includes a series of press nips. The cellulosic fibrous web passes through the press nips supported by a press fabric, or, as is often the case, between two such press fabrics. In the press nips, the cellulosic fibrous web is subjected to compressive forces which squeeze water therefrom, and which adhere the cellulosic fibers in the web to one another to turn the cellulosic fibrous web into a paper sheet. The water is accepted by the press fabric or fabrics and, ideally, does not return to the paper sheet.

The paper sheet finally proceeds to a dryer section, which includes at least one series of rotatable dryer drums or cylinders, which are internally heated by steam. The newly formed paper sheet is directed in a serpentine path sequentially around each in the series of drums by a dryer fabric, which holds the paper sheet closely against the surfaces of the drums. The heated drums reduce the water content of the paper sheet to a desirable level through evaporation.

It should be appreciated that the forming, press and dryer fabrics all take the form of endless loops on the paper machine and function in the manner of conveyors. It should further be appreciated that paper manufacture is a continuous process which proceeds at considerable speeds. That is to say, the fibrous slurry is continuously deposited onto the forming fabric in the forming section, while a newly manufactured paper sheet is continuously wound onto rolls after it exits from the dryer section.

The fabrics generally comprise a woven or other type base fabric. Further, the woven base fabrics may be laminated by placing at least one base fabric within the endless loop formed by another, and by needling a staple fiber batt through these base fabrics to join them to one another as in the case of press fabrics. These woven base fabrics may be of the on-machine-seamable type. In any event, the fabrics are in the form of endless loops, or are seamable into such forms, having a specific length, measured longitudinally therearound, and a specific width, measured transversely thereacross.

In many applications, including spiral wound fabrics (see U.S. Pat. No. 5,360,656 to Rexfelt), knitted fabrics, and laminated fabrics, a mechanism is required to keep the yarns in place and to join the fabric together. For example, a staple fiber batting may be needled through a multiplayer press fabric to keep the fabric together. Other methods include bonding or welding the fabric.

Many types of substrates have been proposed for use in making paper industry process belts. Most belts are composed of a substrate impregnated with a resin to make it impervious to water and oil. Some belts may be formed by taking sheets of rubber or polyurethane and laminating them by applying heat and pressure to a substrate to form a belt. Lamination techniques are also used to form roll covers used in papermaking.

Some exemplary laminated substrates applicable to paper industry process belts are suggested by the following:

U.S. Pat. No. 3,673,023 shows a process for producing a reinforced laminate for use in belts where high tensile strength is required. The belts are made by laying helically wound, continuous reinforcing cords in what is essentially a screw thread or threads extending between the lateral margins of a base. The belt is finished by a top ply laid over the wound carcass, which is then cured with heat and pressure to form a consolidated belt structure.

U.S. Pat. No. 4,109,543 shows a composite laminate. The laminate comprises a hot-melt-type thermoplastic material and a textile woven fabric material formed of spun yarns constructed primarily of staple fibers. They are combined with each other using heat and pressure to form a belt.

U.S. Pat. No. 4,541,895 discloses a press fabric having laminated multiple extruded sheets as support structures with each layer having different properties such as hydrophobicity. Also disclosed are “subassemblies” of various materials which are then spiraled or laid up in parallel strips to form substrates for press fabrics; the subassemblies are formed by techniques including lamination.

U.S. Pat. No. 4,908,103 discloses a grooved shoe press belt having a first and second laminate having differential hardness relative to each other for inhibiting crushing of the venting or drainage grooves.

U.S. Pat. No. 5,208,087 discloses a laminated long nip press belt assembled by spirally winding a layer having a grooved outer surface.

U.S. Pat. No. 5,240,531 shows an endless conveyor belt consisting of a core member and an elastic laminate layer. The layers are passed through a pressing apparatus that bonds them together through the use of heat and pressure.

U.S. Pat. No. 5,792,323 teaches a laminate that includes a spirally wound base fabric and other various types of materials to form a support structure for a belt.

Further to the above disclosures, a long nip press of the shoe type requires a special belt, such as the belt shown in U.S. Pat. No. 5,238,537. This belt is designed to protect the press fabric supporting, carrying and dewatering the paper web from accelerated wear that would result from direct, sliding contact over the stationary pressure shoe. Such a belt must be provided with a smooth, impervious surface that rides, or slides, over the stationary shoe on a lubricating film of oil as the belt moves through the nip at roughly the same speed as the press fabric, while keeping that oil contained within its circumference.

Belts of the variety shown in the '537 patent are typically made by impregnating a woven base fabric, generally in the form of an endless loop, with a synthetic polymeric resin. Preferably, the resin forms a coating of some predetermined thickness at least on the inner surface of the belt, so that the yarns from which the base fabric is woven may be protected from direct contact with the arcuate pressure shoe component of the long nip press. It is specifically this coating which must have a smooth, impervious surface to slide readily over the lubricated shoe and to prevent any of the lubricating oil from penetrating the structure of the belt to contaminate the press fabric, or fabrics, and fibrous web.

The base fabric of the belt shown in the '537 patent may be woven from monofilament yarns in a single- or multilayer weave, and to be sufficiently open to allow the impregnating material to totally impregnate the weave. This eliminates the possibility of any voids forming in the final belt. Such voids may allow the lubrication used between the belt and shoe to pass through the belt and contaminate the press fabric or fabrics and fibrous web.

When the impregnating material is cured to a solid, it is primarily bound to the base fabric by a mechanical interlock, wherein the cured impregnating material surrounds the yarns of the base fabric. In addition, there may be chemical bonding or adhesion between the cured impregnating material and the material of the yarns of the base fabric.

A problem encountered during the dewatering of paper webs in extended nip presses is that a bulge develops in the belt ahead of the nip, which may result in belt failure by delamination of the resin from the substrate. This problem is recognized in U.S. Pat. Nos. 4,229,253 and 4,229,254. Certain belt constructions have been suggested to overcome this problem by providing a base fabric impregnated with a thermoplastic or thermosetting polymeric material.

The monofilaments used to weave the base fabric of the belt shown in the '537 patent have a circular cross section. These monofilaments may be thought of as elongated cylinders. It is well known that a circular cross section provides the monofilament with a certain, defined surface area. Further, the strength of the mechanical interlock and any chemical bond and adhesion, between the cured impregnating material and base fabric, is minimized when the yarns of the base fabric have a circular cross section. As a result, delamination of the coating from the base fabric may occur.

A solution to the problem of delamination is provided by increasing the surface area and by changing the cross-sectional configuration of the yarns making up the base fabric. The connection between the cured impregnating material and the base fabric is strengthened by using yarns having non-circular cross-sections.

Furthermore, in the prior art (e.g. the '537 patent), long nip press belts comprising a textile fabric substrate coated or impregnated with a polymeric resin are produced by first coating or impregnating the substrate with the resin and then forming it into a belt by curing the coated or impregnated substrate. Whereas, in the present invention, a superior belting product is obtained by first coating or impregnating the individual components/layers of the textile fabric substrate with a polymeric resin, combining the coated or impregnated components/layers to form the substrate and then curing the substrate to form the belt.

### SUMMARY OF THE INVENTION

The present invention is a laminate comprising a plurality of preformed layers, wherein a polymeric coating/impregnating material is part of a respective layer. Each preformed layer may be a “textile layer” or a textile layer coated/impregnated with resin. The individual layers of preformed components are first coated or impregnated with a polymer resin and then combined to form the substrate of a belt for papermaking machine applications. That is, the substrate includes the individual components that have been coated or impregnated prior to fabrication for eventual construction of the belt.

The individual components, at least one of which contains a reinforcing agent, may be coated or impregnated with any suitable coating or impregnating material, such as a liquid polymer resin, for example, a polyurethane, by a predetermined method such as that described in the '537 patent, involving heating the base substrate with the polymeric resin at a sufficient temperature to cause the resin to flow into the fabric.

The layers of preformed components coated or impregnated with, for example, a polymeric resin, as described above, are stacked and bonded to form a laminate. The lamination may be achieved by binding the layers together with a fine yarn or needling techniques described in the art. The lamination may also be achieved by incorporating a thermoplastic in one or more of the textile layers and subjecting the substrate to temperatures high enough to cause flow of the thermoplastic resin and bonding of the layered components.

Similarly, in the process of the present invention, layers of fibrous webs comprising matrices of “pre-polymer and curative materials” may be stacked and bonded by subjecting the structure to the appropriate curing temperatures, or by promoting a chemical curing and hardening reaction within the structure. The properties of the laminated substrate and the requirements of use, such as dewatering as in a shoe press belt or sheet support and uniform pressure distribution in the nip; or ease of transfer of the sheet of paper from one position to another may be predetermined by application of these processes in the case of a transfer belt. In other words, belts having specific predetermined properties (including different properties on the face and shoe sides or face and back sides of the belt) may be produced by varying the “layers” or structures used in forming the substrate.

The individual components of the substrate may be formed from monofilaments, multifilaments, plied monofilaments, continuous fine filaments and staple fibers. The monofilaments may include single continuous filaments, which may be twisted or not twisted, having diameters from about 0.004 inches to about 0.06 inches, comprising synthetic polymeric material, such as polyamides and polyesters. The multifilaments may include flexible yarns composed of numerous fine, continuous strands, and generally several highly twisted bundles of the strands. The staple fibers may include relatively short fibers which are formed into a layer by one of several textile methods such as carding or spun bonding. Spun bonded webs and their methods of preparation are well known in the art. For example, U.S. Pat. No. 5,750,151 to Bregnala, describes the fabrication of spun bonded webs by extrusion of multifilaments derived from thermoplastic polymers, such as polyolefins (polypropylene), polyesters (polyethylene terephthalate), polyamides (nylon-6), and polyurethanes, for industrial use.

### BRIEF DESCRIPTION OF THE DRAWINGS

FIG. 1 is a section side view of a laminated substrate of a belt in accordance with an embodiment of the present invention;

FIG. 2 is a cross-sectional view of an embodiment of a non-round textile yarn used in the components shown in FIG. 1;

FIG. 3 is a cross-sectional view of an alternative textile yarn used in the components shown in FIG. 1; and

FIG. 4 is a perspective view of an alternative embodiment of the substrate of the belt of the invention.

### DETAILED DESCRIPTION OF THE INVENTION

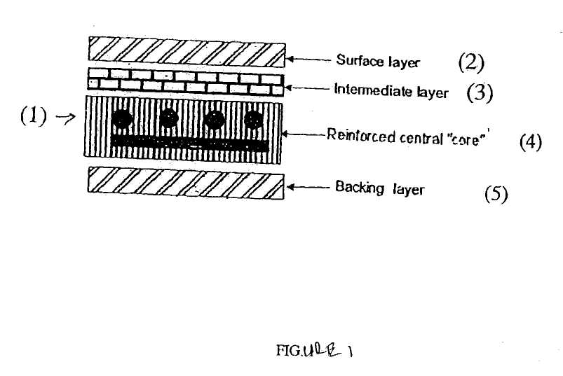

Referring to the drawings, FIG. 1 shows a layered substrate (1) of a long nip press belt for use in a papermaking machine in accordance with the teachings of the present invention. The substrate (1) comprises a surface layer (2), an intermediate layer (3), a reinforced central “core” (4) and a backing layer (5). The layers are individually coated with a polymeric resin, combined and secured by methods which may include those known in the art, and the composite forms the substrate of the belt for applications in papermaking machines.

The belt substrate of the present invention is a laminate comprising a plurality of preformed layers wherein a polymeric coating/impregnating material is part of at least one respective layer and may be part of each layer.

Each preformed layer may be a “textile layer” or a textile layer coated/impregnated with resin. The individual layers may be first coated/impregnated with a polymer resin and then combined to form the substrate of the belt for papermaking machine applications. The coating/impregnating of the layers of the textile substrate can be carried out by the process described in U.S. Pat. No. 5,753,085 to Fitzpatrick, whose teachings are hereby incorporated herein by reference. The combination of the individual layers and the lamination of the layers is preferably performed by heated rolls, hot air boxes or chambers, or other known methods of applying heat, in addition to gluing with flexible adhesives. Alternatively, the layers may be laminated together by promoting a chemical reaction between respective layers.

At least one layer of the substrate of the belt may be reinforced with components of reinforcing material to provide the belt with stability in both the machine direction (MD) and cross-machine direction (CD) (or longitudinal and transverse directions) during the manufacturing process. In FIG. 1, the central “core” layer (4) includes this reinforcing material.

The textile substrate may be constructed as a woven fabric of a simple or complex single- or multilayer weave, the yarns of which comprise a polymeric resin material such as a polyester or a polyamide, a non-woven MD (machine direction) or CD (cross direction) matrix of continuous filaments, a nonwoven sheath of fibers, a film or extruded mesh, or any combination thereof.

The polymeric resin material also impregnates the textile substrate and renders the layer impervious to oil and water. The polymeric resin material may be polyurethane, preferably a 100% solid composition thereof, to avoid the formation of bubbles during the curing process through which the polymeric resin material proceeds following its application onto the textile substrate. After curing, the polymeric resin material may or may not be ground and buffed to provide the layer with a smooth surface and a uniform thickness. Where both sides of the textile substrate are coated with a polymeric resin material, the cured coating on both sides may be ground and buffed to provide smooth surfaces and a uniform thickness or thicknesses. It is noted that the polymeric coating material may be a thermoplastic resin, thermosetting polymer, or rubber material. For example, Polyurethane, polyethylene, polypropylene and silicone are resins than can be used as a coating material.

The present process involves incorporating a thermoplastic or pre-polymer and curative (to form a polymer) in one or more of the components (2), (3), (4) or (5), or incorporating a layer of fusible material which may be a thermoplastic between layers, combining the components (2), (3), (4) or (5), and bonding the components (2), (3), (4) or (5), by subjecting the combination to elevated temperatures and pressure in a laminating process. Any thermoplastic that softens and flows at an elevated temperature may be used as the coating or impregnating resin.

Prepolymers and curing agent processes for curing (hardening) the prepolymer are described in the art. For example, the moisture curing of urethane prepolymers in the presence of a morpholine catalyst is disclosed in U.S. Pat. No. 6,362,300, and the coating of cured urethane acrylate prepolymer is reported in U.S. Pat. No. 5,976,307.

Additionally, the entire substrate may be further coated or impregnated with a polymeric resin in a manner similar to the coating of each individual layer. Alternatively, the substrate may be coated or impregnated with a prepolymer and a curing agent, and allowed to stand at room temperature or heated to accomplish the hardening of the polymer. The curing of the prepolymer may also be accomplished by incorporating a catalyst in the matrix to modulate the curing process. The curing process may be controlled by selection of the prepolymer and curing materials and the conditions of the process to provide substrates of a belting product having desirable characteristics, including different characteristics on the front and back sides of the belt.

A primary function of the substrate is to provide the belt with dimensional stability. Further, the substrate may provide sufficient void and surface area onto which additional polymeric resin material may be subsequently applied. The substrate may also prevent the passage of the polymeric resin material to the opposite side of the substrate, so that sufficient sites might be available on that opposite side for a coating, optionally, of a different polymeric resin material.

Moreover, when the outer surface of the belt has a resin coating of some predetermined thickness, it permits grooves, blind-drilled holes or other cavities to be formed on that surface without exposing any of the substrate layers. These features provide for the temporary storage of water pressed from the paper web in a press nip, and are usually produced by grooving or drilling in a separate manufacturing step following the curing of the resin coating. The present belt may have such grooves or blind-drilled holes in its outer surface.

The foregoing embodiments of the present invention have been described in the context of a preassembly for a substrate or base substrate for a papermaker's coated process belt. Substrate constructions used herein include woven, and nonwoven materials such as knitted, extruded mesh, spiral-link, MD or CD yarn arrays, and spiral wound strips of woven and nonwoven materials. These substrates may include yarns of monofilament, plied monofilament, multifilament or plied multifilament, and may be single-layered, multi-layered or laminated. The yarns are typically extruded from any one of the synthetic polymeric resins, such as polyamide and polyester resins, used for this purpose by those of ordinary skill in the industrial fabric arts.

Returning now to the yarns used in the construction of the textile substrate, the monofilaments, multifilaments, continuous fine filaments and/or staple fibers may have a circular or a non-circular cross section. Preferably, the non-circular cross sections would be profiled or multi-lobed.

FIG. 2 shows a cross-sectional view of a textile yarn (9) used in preparing the substrate (1) of the present invention. The reinforcing components designated (4) in FIG. 1 comprise any conventional textile yarns interwoven lengthwise and crosswise to provide fabric stability. Any conventional yarn such as monofilament, multifilament, continuous fine filaments or spun yarns of synthetic fibers may be selected. The yarn's fibers are composed of resins from the family of polyolefins, polyamides, polyesters, polyamids and blends thereof and the like. The textile yarns (9) are conveniently prepared by extrusion from a polymer resin, i.e., a polyester or polyamide, or by methods known in the art from such resins in a configuration, for example, with multiple lobes (6) which provides a surface area greater than that of a circular configuration resulting in a yarn with the desired improved adhesion to the resins. A yarn with three such lobes (6) is shown in FIG. 2.

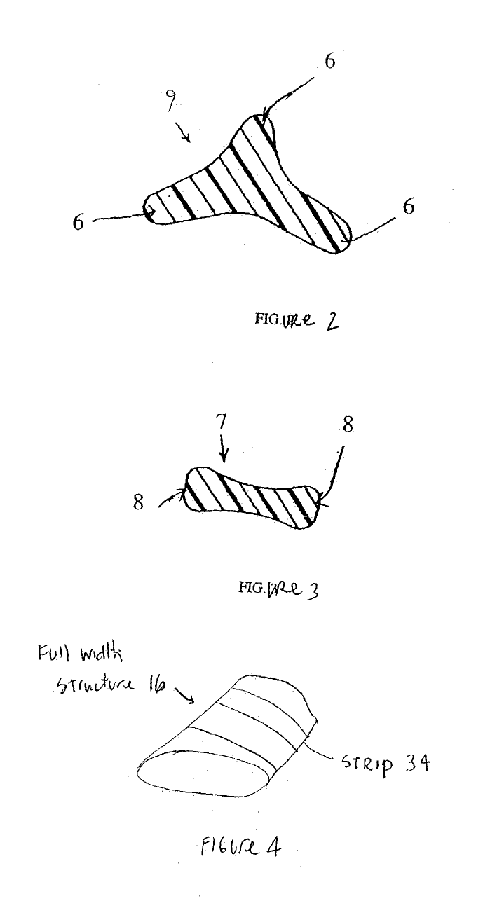

FIG. 3 is a cross-sectional view of an alternative configuration of a textile yarn (7) included in the substrate (1) of the present invention. This textile yarn (7) has two lobes (8), which like the three lobe yarn (6) of FIG. 2 and other multiple lobe yarns, has a greater surface area than yarns with a circular cross-section. Also like the three- and multiple lobe yarns, the two lobe yarns (7) are prepared by extrusion from a polymeric resin by known methods.

Filaments and fibers of profiled or multi-lobed cross section have greater surface areas than those of the same denier having a circular cross section. In the present invention, the greater surface area of the filaments and/or fibers is available to increase the chemical bonding or adhesion of the coating material thereto. The profiled or multi-lobed cross sections also restrict the amount of coating material able to flow through the textile substrate, and improve the mechanical interlock between the cured coating material and the textile substrate. Filaments and fibers of profiled or multi-lobed cross section can also lower the permeability of the textile substrate to prevent or control the passage of polymeric resin material to its opposite side, so that the opposite side might remain free of coating, or retain a number of sufficient sites, available for a coating, optionally of a different polymeric resin material. The subject filaments and fibers give the substrate a greater surface-area-to-weight ratio than that which could be obtained using yarns of circular cross section.

Where the textile substrate comprises monofilaments, it may be interwoven from machine (longitudinal) direction and cross machine (transverse) direction monofilament yarns in a single- or multi-layer weave. Continuous filaments might be used to form a non-woven matrix for use as the textile substrate or a nonwoven spun bonded sheet. The staple fibers, finally, may be used in the form of a batt as the textile substrate. The batt may be needled into a base fabric, or used separately, to provide the textile substrate. The monofilaments, continuous filaments or staple fibers having cross sections with a plurality (greater than one) of lobes might be used in producing the textile substrates for the belts of the present invention. Batts of staple fibers as defined above can be needled into a substrate.

Modifications to the above would be obvious to one of ordinary skill in the art, but would not bring the invention so modified beyond the scope of the appended claims. For example, the substrate (1) and/or its component layers (2), (3), (4), (5) shown in FIG. 1 need not be a full width structure but instead can be, as shown in FIG. 4, a strip of material (34) such as that disclosed in U.S. Pat. No. 5,360,656 to Rexfelt, the disclosure of which is incorporated herein by reference, and subsequently formed into a full width fabric (16). The strip (34) can be unwound and wound up on a set of rolls after fully processing. These rolls of fabric materials can be stored and can then be used to form an endless full width structure (16) using, for example, the teachings of the immediately aforementioned patent.

1. A substrate useful for making an endless belt in a papermaking machine application comprising a plurality of preformed layers and a polymeric coating or impregnating material or rubber material that is part of a respective layer, wherein each preformed layer is a textile layer or a textile layer coated/impregnated with resin or the rubber material, and at least one layer of which contains a matrix of reinforcing components.

2. The substrate according to claim 1 wherein the layers are stacked in the form of a laminate.

3. The substrate according to claim 2 wherein the required number of layers is stacked for a particular application of the belt in a papermaking machine.

4. The substrate according to claim 1 wherein the preformed layers are comprised of woven, nonwoven or spiral wound strips of woven and nonwoven materials.

5. The substrate according to claim 4 wherein the nonwoven materials are spun bonded, wet laid, air laid, knitted, extruded, or spiral-linked.

6. The substrate according to claim 1, wherein the substrate is coated on at least one outside surface with a polymeric resin material or the rubber material.

7. The substrate according to claim 6, wherein the polymeric resin material is a thermoplastic resin or thermosetting polymer.

8. The substrate according to claim 7 wherein the resin is from the group consisting of polyurethane, polypropylene, polyethylene, and silicone.

9. The substrate according to claim 1, wherein at least one preformed layer is comprised of yarns having a circular cross section.

10. The substrate according to claim 1 wherein the reinforcing components are fabricated from monofilaments, multifilaments, continuous fine filaments or spun yarns of synthetic fibers.

11. The substrate according to claim 10, wherein the filaments or fibers have profiled or multi-lobed cross sections.

12. The substrate according to claim 1, wherein an outer surface of the substrate has grooves or blind-drilled holes.

13. The substrate according to claim 1, wherein the layers include:
a. a surface layer;
b. an intermediate layer;
c. a reinforced central core layer; and
d. a backing layer.

14. A method of making a substrate of an endless belt to be used in papermaking applications comprising the steps of:
a. coating or impregnating at least one layer of a plurality of layers of a material, at least one of which contains a reinforcing material, to form a preformed coated or impregnated layer;
b. combining the coated or impregnated layers to form a structure; and
c. processing the structure to form a laminate.

15. The substrate according to claim 14, wherein at least one layer is comprised of yarns having a circular cross section.

16. The method according to claim 14 wherein the layers are comprised of monofilaments, multifilaments, continuous fine filaments, or staple fibers.

17. The method according to claim 16 wherein the filaments or fibers have profiled or multi-lobed cross-sections.

18. The method according to claim 16 further comprising a step of creating grooves or blind-drilled holes in an outer surface of the substrate.

19. The method according to claim 14 wherein the at least one layer is coated or impregnated with a polymeric resin.

20. The method according to claim 19 wherein the polymeric resin is from the group consisting of polyurethane, polypropylene, polyethylene, and silicone.

21. The method according to claim 19 wherein the polymeric resin is in the form of a sheet.

22. The method according to claim 14, wherein the reinforcing material is comprised of woven, nonwoven or spiral wound strips of woven and nonwoven materials.

23. The method according to claim 22, wherein the nonwoven materials are spun bonded, wet laid, air laid, knitted, extruded, or spiral-linked.

24. A method of making a substrate of an endless belt to be used in a papermaking application comprising the steps of:
a. combining preformed layers of a material containing a matrix of a prepolymer and a curing agent to form a structure;
b. processing the structure to form a laminate; and
c. curing the structure.

25. A method of producing a papermaker's process belt comprising the steps of:
coating or impregnating at least one layer of a plurality of layers of a preformed material with a polymer resin or rubber material, wherein at least one layer includes a reinforcing component for stability in a machine direction (MD) or a cross-machine direction (CD) of the belt;
combining the layers to form a substrate or base substrate; and
forming the substrate or base substrate into an endless belt.

26. The method according to claim 25, further comprising the step of coating the belt with a polymeric resin or a rubber material on at least one outside surface.

27. The method according to claim 25, wherein said layers are laminated together by promoting a chemical reaction between respective layers.

28. The method according to claim 25, wherein said layers are laminated together using heat and pressure.

29. The method according to claim 25, wherein a respective layer is of a construction taken from the group consisting essentially of woven, or nonwoven, such as spiral-link, MD or C D yarn arrays, knitted, extruded mesh, or material strips which are ultimately spiral wound to form a substrate having a width greater than a width of the strips.

30. The method according to claim 25, wherein a component in a respective layer is one of thermoplastic, thermoset, reactive materials or rubber material.

31. The method according to claim 25, wherein a respective textile layer is made by one of spun bonded, wet laid and air laid processes impregnated with a polymer resin or a rubber material.

32. A papermaker's process belt comprising layers of preformed material that are first coated with a polymer resin or rubber material and then combined to form a substrate of the belt, wherein at least one layer includes a reinforcing component for stability in a machine direction (MD) or a cross-machine direction (CD) of the belt.

33. The belt according to claim 32, wherein the finally formed belt has a resin-coat or a rubber material on at least one outside surface.

34. The belt according to claim 32, wherein the layers are laminated together by promoting a chemical reaction between respective layers.

35. The belt according to claim 32, wherein the layers are laminated together using heat and pressure.

36. The belt according to claim 32, wherein a respective layer is of a construction taken from the group consisting essentially of woven, or nonwoven, such as spiral-link, MD or CD yarn arrays, knitted, extruded mesh, or material strips which are ultimately spiral wound to form a layer having a width greater than a width of the strips.

37. The belt according to claim 32, wherein the polymer resin is one of thermoplastic, thermoset, or reactive materials.

38. The belt according to claim 32, wherein a respective textile layer is made by one of spun bonded, wet laid and air laid processes impregnated with resin or a rubber material.

39. The substrate according to claim 1, wherein the polymeric resin material is a thermoplastic resin or thermosetting polymer.

40. The substrate according to claim 1 wherein the resin is from the group consisting of polyurethane, polypropylene, polyethylene, and silicone.
